(19) United States
(12) Patent Application Publication
(10) Pub. No.: US 2023/0214430 A1
(43) Pub. Date: Jul. 6, 2023

(54) DYNAMICALLY DECIDE DATA OPERATIONS BASED ON INFORMATION TYPE TO SATISFY BUSINESS USER NEED

(71) Applicant: MICROSOFT TECHNOLOGY LICENSING, LLC, Redmond, WA (US)

(72) Inventors: Xi YUN, Redmond, WA (US); Jiantao SUN, Bellevue, WA (US); Zheng CHEN, Bellevue, WA (US); Jianwen ZHANG, Sammamish, WA (US); Wei LI, Bellevue, WA (US); Yaxi LI, Bellevue, WA (US); Li WANG, Redmond, WA (US); Deren LEI, Bellevue, WA (US)

(21) Appl. No.: 17/566,206

(22) Filed: Dec. 30, 2021

(51) Int. Cl. G06F 16/9532; G06F 16/9535; G06F 16/951

(52) U.S. Cl. CPC G06F 16/9532; G06F 16/9535; G06F 16/951

(57) ABSTRACT

Systems are configured for processing user queries to generate search results that are contextually relevant for the user based on customer values associated with a corresponding customer schema associated with the user and that are indexed in a customer value index. When search queries are received, they are processed to identify customer values associated with the user context and to perform an initial search query based on the initial search query terms. The systems also generate additional altered search queries to perform contemporaneously, based on the initial search terms and restructured/reformatted based on the customer values. Resulting supplement search results are obtained for the additional altered search queries, which are merged with the initial search results. The merged results are then ranked and provided to the user. These systems facilitate obtaining search results that are more relevant than results obtained by conventional systems.

### BACKGROUND

Many business users need to search data in their day-to-day business activities. For example, a seller may need to find contact information of their customers by querying a name or other contact information terms associated with a contact. Other business users may need to search for relevant resources or documents associated with a particular project or job.

To help navigate and find relevant documents, many tools and platforms have been designed to assist with storing and accessing data in local storage, as well as in distributed and wide area networks, such as the Internet.

The Internet, for example, stores and indexes a variety of media content, including audio content, literary content, and mixed-media content, all of which can be searched and rendered with specialized browsers, media players and other specialized user interfaces. There are also various search engines and specialized applications that are configured to assist with storing and accessing data maintained in enterprise and other locally secured and private databases.

Existing search service tools typically include a query field where a user can type in text comprising search terms to be used by the browser or other searching tool when searching the relevant databases (also referred to herein as repositories) for content related to the search terms.

Many existing search tools also utilize learn-to-rank type functionality, for ranking and sorting content that is identified as being potentially relevant to a user's search terms. Using this functionality, for instance, a browser or other search tool is enabled to rank and sort a plurality of possible search results according to a determined order of perceived relevance for the user, based on the user's search terms, with the most relevant search results presented first and/or at least at the top of a listing of a plurality of potentially relevant search results. Various algorithms are used to determine relative relevance of the different search results prior to presenting those results to the user.

However, even though many conventional browsers and search tools utilize learn-to-rank models in their searching functionality, many users still struggle finding content that is most relevant to the user's current needs and desires. Some of these difficulties are based on inadequate training of the search engines and models that are used to perform the search processing. In particular, while some initial training of the search engines and models has been performed, this training is not always compatible with the needs and interests of a particular user. Many search services are also not specifically trained for the customized schemas used by different entities for indexing the stored data.

Conventional search engines and search services are typically configured with search and rank models that are trained on generic and public records associated with stored documents and search query terms used by the public and search engines at large. However, this public information is not always the best information to use when training models that are used in specific and different ways by different entities, particularly when those entities utilize different schemas and business terms defining and storing their data.

Unfortunately, logistical constraints associated with privacy concerns often inhibits the procuring the specific and most relevant training data that could be used for training and tuning the algorithms used by the search engines and corresponding learn-to-rank models. By way of example, a private enterprise may include customers and employees that perform various types of data searching, using specific types of queries, for searching enterprise resources stored in their private databases. They may also use proprietary and/or confidential search terms on public and distributed databases. In both instances, the enterprise may not want to expose their database content and/or search query term(s) that are used to the public at large, including to public web crawlers and analytics tools that can be used to evaluate heuristics for refining the search algorithms and techniques used by the search engines.

Yet another related problem with existing learn-to-rank type models is that they are not often trained to infer a user's underlying intentions behind the search terms that are entered. Instead, they are simply focused on finding results that may include all the search terms or that could somehow be determined to be relevant to the query search terms (e.g., any and all documents including synonyms, derivatives, or other related terms to the search terms) which may be pulled from a corpus of all available documents in one or more different search repositories. By searching all possible locations, without scoping the search, many conventional systems return search results that are diluted with undesired documents and other content that the user does not want to see.

By way of example, when a search term is a string of characters comprising a name, a phone number, an email address and/or a random term, the user who typed in the search term(s) may have certain intentions behind what they are looking for and may be looking for only exact matches, if any exist. They do not want to be inundated with all resources containing the same or similar string of characters. This is particularly true, for example, when the user is looking for contact information associated with a particular phone number or email address for a customer of a particular job.

In yet, other instances, the user may want an inclusive list of all potentially relevant documents associated with the search term(s), regardless of whether the documents include the search term(s). This can be helpful when doing research on a particular topic.

While, in other circumstances, a user may want to see only a few documents that are determined to be most relevant or a particular type of document or media format that is determined to be relevant to the search term(s). Results of this type of scoped or focused search could be managed by a user specifying the specific domains or search repositories to search, which contain the corresponding type of documents or media formats. However, not all users are sophisticated enough to generate queries that are scoped to search for only selected tables or domains for information that is being sought.

A specific example will now be provided to illustrate this point further. Suppose, for instance, a user enters the term “300”. Depending on context and intended scope of the search, the user may be seeking information related to the movie “300”. Alternatively, the user may be seeking information for a business or other entity associated with the area code “300”, or a department, customer identifier, order number, or building number. The number 300 may also mean different things to different companies and users.

However, unless the user is able to specify the constraints of the search, conventional search engines will search all available repositories for all relevant information related to the term “300,” even if it is information that is not desired or relevant for a particular customer/user.

Unfortunately, with many conventional systems, even if a user is able to add additional parameters within the search query for scoping/limiting the intended type of media that is desired, the conventional systems will still search all available repositories for that focused content, even though many of the tables and other storage structures in the searched repositories do not contain any information of the type that is desired.

In view of the foregoing, as well as other problems existing within the field of data management and search services, including learn-to-rank model processing and other search service processing, there is an ongoing need to improve the manner in which search services and related learn-to-rank models are configured and trained for scoping and performing search queries based on user intentions and relevant context.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

New and improved methods, systems, products, and devices are provided for facilitating the processing of search queries and, even more particularly, for facilitating a manner in which search services and related learn-to-rank models are configured and trained for scoping and processing search queries based on user intentions and relevant user context based on customer schemas and other customer information associated with the corresponding users.

Disclosed embodiments include and/or utilize systems configured for dynamically processing search queries based on customer information, such as, but not limited to customer schema information. Such systems are configured, for example, to identify an initial search query of a user, wherein the user is associated with a customer schema indexed in a customer value index that correlates customer values with corresponding customer schemas. Then, based on a context of the search query, including the association of the user with the customer schema indexed in the customer value index, the systems obtain (1) one or more initial search results based on the initial search query from a repository that includes resources that are indexed and searched by the index search service, and (2) one or more customer values associated with the customer schema and/or other customer information.

The systems also concurrently (in parallel) generate one or more altered search queries based on the initial search query as well as the one or more customer values and submit the one or more altered search queries to the index search service to receive one or more corresponding supplemental search results. The results of the initial search results are merged with the search results obtained for the altered search queries to provide the final results that are ranked and presented to the user.

Processes implemented by the system for generating the altered search queries includes one or more of the system (1) rewriting one or more search terms in the initial search query based at least in part on the one or more customer values obtained from the customer value index, (2) identifying one or more entities associated with the search query based at least in part on the one or more customer values that are obtained from the customer value index, the one or more entities comprising a scope of resource type to search by the index search service, (3) identifying one or more predicted storage structures to limit the search query to by the index search service based at least in part on the one or more customer values that are obtained from the customer value index, the one or more predicted storage structures being a subset of all storage structures available for searching by the index search service, and/or (4) generating a structured query from one more search terms in the search query. The structured query can also be generated at least in part based on the one or more predicted storage structures and/or the one or more entities to further scope the altered queries.

As noted, the disclosed systems also generate merged search results by at least merging the initial search results with the one or more supplemental search results and further rank the merged search results to generate a final set of ranked and merged search results for presentation to the user in response to the initial query.

In some instances, the systems further implement feedback loops to improve training of the learn-to-rank models used by the systems by obtaining feedback associated with the ranked and merged search results and responsively, based on the feedback, modifying at least one of (1) the model(s) used to generate the ranked and merged search results or (2) the ranked and merged search results themselves. The feedback may include any user interaction with the ranked and merged search results, such as user input selecting or accessing a resource identified in the ranked and merged search results. The feedback may also, alternatively or additionally, include a determination that one or more resources included in the ranked and merged search results is not selected or accessed by the user within a predetermined time.

This Summary is provided to introduce a selection of concepts in a simplified form that are further described below in the Detailed Description. This Summary is not intended to identify all the key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a computing environment in which a computing system incorporates and/or is utilized to perform disclosed aspects of the disclosed embodiments for processing search queries.

FIG. 2 illustrates another computing environment in which a computing system incorporates and/or is utilized to perform disclosed aspects of the disclosed embodiments for processing search queries.

FIG. 3 illustrates an embodiment of system model components and a flow corresponding to disclosed features and functionality for the disclosed computing systems to process search queries.

FIG. 4 illustrates one embodiment of a flow diagram having a plurality of acts associated with methods for processing search queries based on customer information.

FIG. 5 illustrates one embodiment of a flow diagram having a plurality of acts associated with obtaining search results and customer values associated with an initial search query.

FIG. 6 illustrates one embodiment of a flow diagram having a plurality of acts associated with generating one or more altered search queries from an initial search query.

### DETAILED DESCRIPTION

Disclosed embodiments include methods, systems, products, and devices for facilitating the processing of search queries and, even more particularly, for facilitating a manner in which search services and related learn-to-rank models are configured and trained for scoping and processing search queries based on user intentions and relevant user context based on customer schemas and other customer information associated with the users.

There are many technical benefits associated with the disclosed embodiments, including the functionality provided by the disclosed systems for performing search services in a manner than facilitates obtaining search results that are contextually relevant to a user, with a breadth and depth that is not accessible with conventional systems. This functionality is aided by the systems supplementing initial queries with supplemental altered queries that are based on the initial queries as well as unique customer information related to the user. The technical benefits further include facilitating the generation of the supplemental and altered search queries without requiring the user to explicitly provide the syntax for restructuring the altered search queries. The technical benefits also include facilitating a manner in which corresponding search results are merged and ranked for the user. The technical benefits also include facilitating training of learn-to-rank models in a manner that considers user intention for different search queries, as well as user interactions with the search result content, to improve the manner in which the models are able to identify relevant search results.

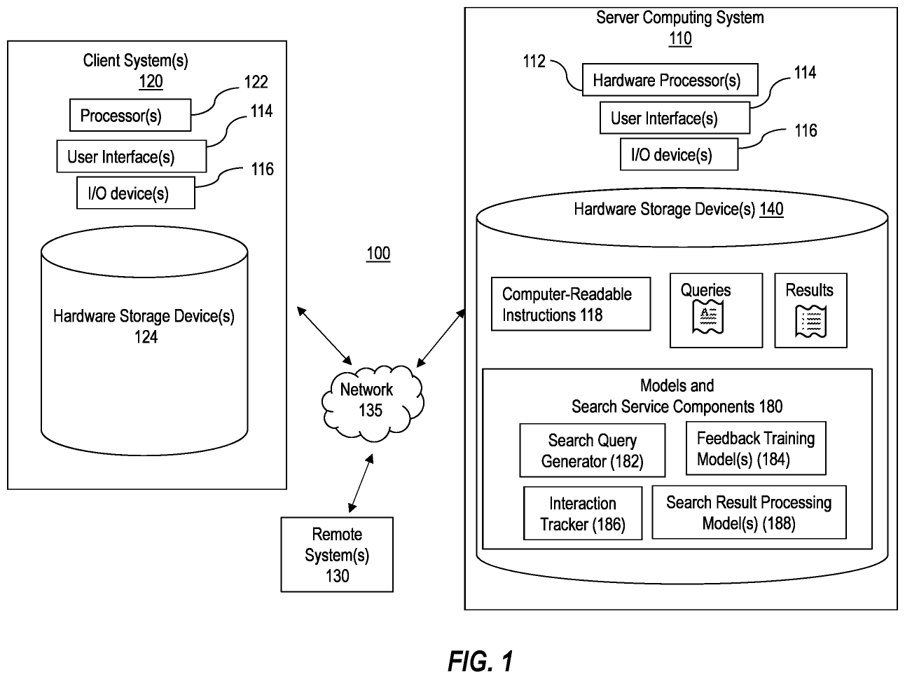

Attention will now be directed to FIG. 1, which illustrates computing systems and various components of the computing systems which may include and/or be used to implement aspects of the disclosed invention.

As shown, a first or server computing system 110 is illustrated as being incorporated within a broader computing environment 100 that also includes one or more client systems, as well as one or more remote system(s) 120 communicatively connected through one or more network connection(s) of a network 135 (e.g., the Internet, cloud, or other network connection(s)).

Each of the server computing system 110 and client system 120 include one or more processor(s) (112, 122) and one or more computer-executable instruction(s) (118) stored in corresponding hardware storage device(s) (140, 124, although only presently shown in hardware storage device(s) 140), for facilitating processing/functionality attributed to those systems and as described herein.

Although not presently shown, each of the remote system(s) 130 also comprise one or more processor(s) and one or more computer-executable instruction(s) stored in corresponding hardware storage device(s), for facilitating processing/functionality at the remote system(s), such as when the computing system 110 or client system 120 is distributed to include remote system(s) 130.

Each of the systems (110, 120, 130) also includes corresponding I/O device(s) 116 for receiving input (e.g., user queries) and for providing output (e.g., search result content), which can be stored in one or more of the system hardware storages 124/140 for processing and presentation, as needed. The system I/O devices 116 include keyboards, application interfaces, mouse controllers, touch pads, gesture sensors, screens, speakers, microphones, etc. The I/O device(s) 116 can also be used to access and interact with user/client data and to interface with and communicate with each of the different systems (110, 120, 130).

Each of the systems may also include specialized user interfaces 114, such as software and hardware interfaces for facilitating communications between the different systems, applications, models and other system components. In some instances, these interfaces 114 include APIs (application program interfaces), such as a CDS (core data services) APIs, search browser interfaces, network communication interfaces and so forth.

As shown, server system 110 stores the various models and model generating/modifying components 180 that are used to implement the functionality described herein (e.g., browsers and search engines, algorithms, machine learning or machine learned models, etc.). In some instances, these models/components include the referenced search query processing model(s) 182, feedback training model(s) 184, interaction tracker 186 and search result processing model(s) 188, each of which will be described in more detail below.

Although not shown, the models and model generating/modifying components also include various other NLU/NLP (natural language understanding/natural language processing) components that are configured to analyze and process the different queries and results referenced herein, such as while performing runtime NLU/NLP tasks. In some instances, the NLU/NLP components are also configured to annotate different queries and/or search results to generate annotated NLU/NLP data, which is referenced herein, and which can be used to further train the models for improved accuracy and performance, as well as to facilitate feedback process changes that can be made to improve the overall system.

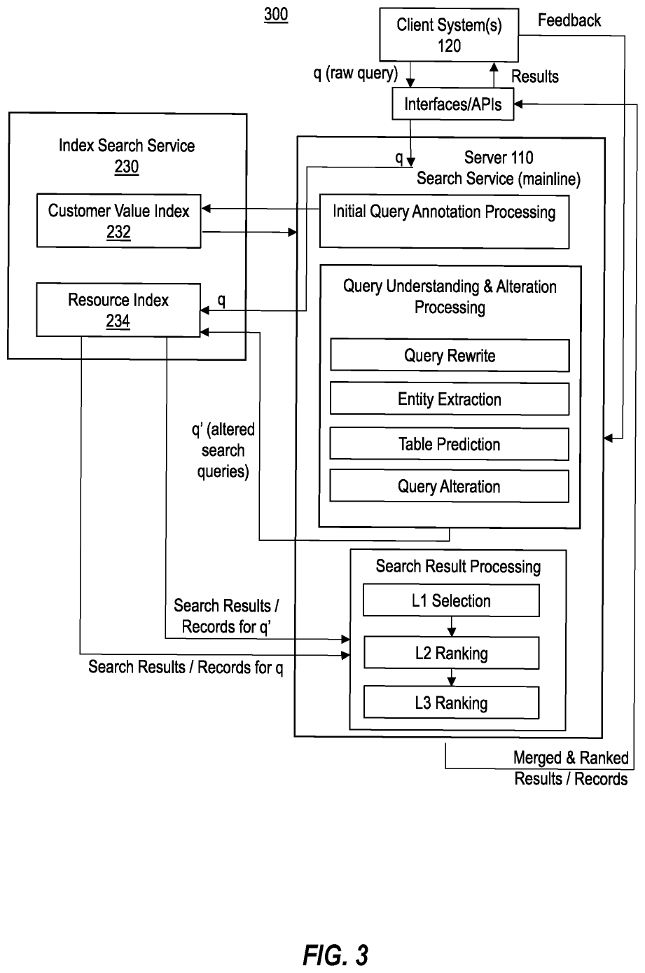

All of the model and search service components (180) can also be stored (partially or entirely) within the client system 120 and remote system(s) 130. These models and components are used to perform the search service processing described herein. The search service processing, which may be divided between the different systems (110, 120, 130) will be described in more detail with reference to FIG. 3 and the search service mainline processing performed by system 110 and the index search service processing performed by remote system 130 (index search service 230).

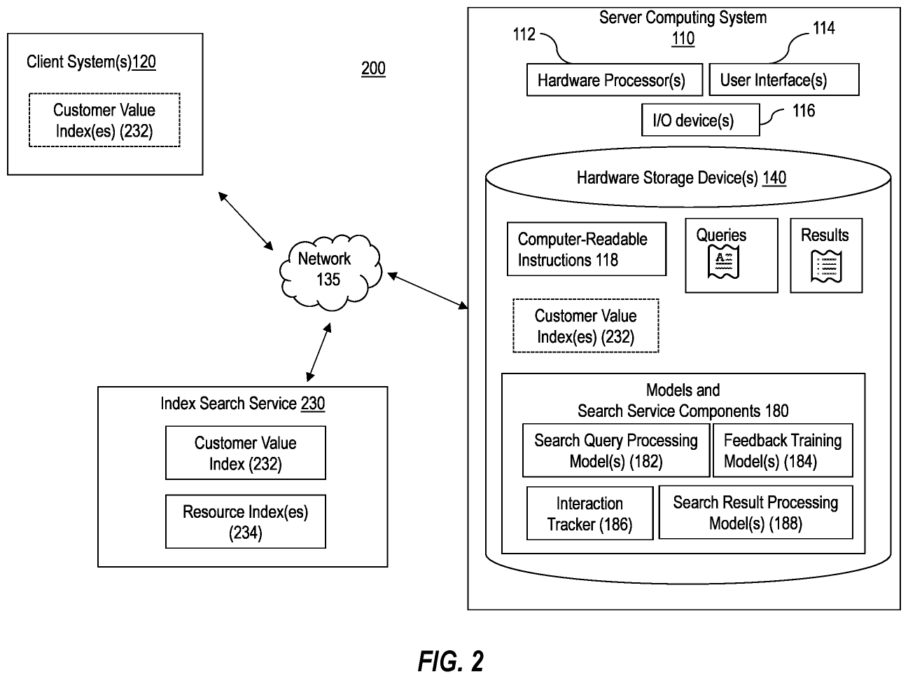

The distribution of models and system components used to perform the search services described herein is more apparent in reference to the illustration of FIG. 2 and the processing flows shown in FIG. 3. In FIG. 2, remote system(s) 130 is represented as index search service 230. In this illustration, the index search service 230 includes customer value index 232 that indexes identify customer values associated with different users/customers, based on the different schemas associated with the different customers, and that are used to generate altered search queries based on original search queries.

Notably, while the customer value index 232 is shown to be stored at index search service 230 (remotely from server computing system 110), the customer value index 232 can be stored partially, entirely at server 110. The customer value index 232 can be distributed and/or stored in duplicative structures at the different locations.

The data used to populate the customer value index 232 includes schema data that defines the shape and types of data stored in customer records. Many customers have proprietary terms and values used to classify the types and formatting of their stored data. The descriptive attributes used to classify data types and shape is collectively referred to herein as schema data. In some instances, the schema data defines whether stored data comprises an integer, string, symbol, or other format, as well as property and ownership information, such as author, owner, user, role, or other information, as well as access rights and privilege information associated with the data. In some instances, the schema data further defines formatting and storage locations (e.g., particular tables or portions of tables where the data is stored). The foregoing examples are nonlimiting, inasmuch as there are numerous variations as to what schema information can be used and how it can be defined by different customers.

In some instances, customers provide schema definitions to the system 110 and/or the index search service 230 to be indexed in the customer value index 232. Additionally, or alternatively, the schema definitions are obtained automatically by models that parse and analyze customer databases and records.

The schema definitions that are indexed reference and associate different customers (and optionally their users) to different values (e.g., terms, data types and storage locations, used by the schema definitions) that may be relevant to the different customers/users that are searching for content in their data repositories, as well as when searching general public databases. Notably, each of the different customers/users will be indexed with different corresponding customer values, based on the different corresponding customer schemas, by the customer value index (232). There may also be a separate customer value index 232 for each customer (although not presently shown).

Additionally, the index search service 230 may also include the various resource indexes 234 that are referenced for search queries and that index search terms and the different customer database records and/or other general public databases that may include those search terms. In some instances, resource index(es) 234 may consist of only a single index for a single customer, based on indexed records associated with that particular customer. Alternatively, or additionally, the resource index(es) 234 may include different indexes for a plurality of different customers.

In some instances, the customer value index 232 stores specific client/user data that is confidential and that they do not want publicly shared or available for unrestricted public inspections, such as occurs with conventional browsers and web crawlers. Accordingly, the index search service 230 and/or server 110 may implement firewalls or other security mechanisms to effectively create a security or privacy enclave for specific client/user data. In these instances, the customer value index 232 may be, optionally, stored at the client system 120 or in an enclave associated with the client system at either the index search service 230 or the server 110.

In instances where the customer value index 232 is distributed or stored remotely from the client system 120, the content of the customer value index 232 is stored with privacy protections that preventing general unfettered public inspection of the data.

As generally suggested earlier, some conventional search services struggle with providing users with search results that are sufficiently targeted to their true intentions and that are scoped to the relevant documents they are searching. The currently disclosed systems help overcome many of these problems by providing functionality that facilitates obtaining search results that are contextually relevant to a user, with a breadth and depth that is not accessible with conventional systems. This functionality is aided by the systems supplementing initial queries with supplemental altered queries that are based on the initial queries as well as unique customer information related to the user.

The technical benefits further include facilitating the generation of the supplemental and altered search queries without requiring the user to explicitly provide the syntax for restructuring the altered search queries. The technical benefits also include facilitating a manner in which corresponding search results are merged and ranked for the user to provide search results of most likely relevance. The technical benefits also include facilitating training of learn-to-rank models in a manner that considers user intention for different search queries, as well as user interactions with the search result content, to improve the manner in which the models are able to identify future relevant search results.

Attention will now be directed to FIG. 3 to illustrate some of this functionality in terms of the search service processing performed by the disclosed systems.

As shown in FIG. 3, the search processing starts when a client system sends in a search query. This search query can come from a user (comprising an individual person and/or a company computing application or other entity). The initial search queries that are received may be strings of characters (e.g., numbers, letters, words, phrases, special characters, etc.). Various browsers, applications, APIs and/or other interfaces may be used to format and transmit the queries to the server 110. These same interfaces may be used to present the search results back to the customer, when they are generated.

Each user that provides the search query may be associated with a particular and unique customer identifier, based on personally identifying information, system identifiers, customer credentials and/or other account information. The unique custom identifier (UCI) of the user can be used to correlate the user with a unique set of customer values that are indexed by and/or stored by the index search service within the customer value index 232, which are associated with a unique customer schema corresponding to that user/customer, for example.

To facilitate the identifying of the relevant customer values for a particular user, the client system, server system and/or search service will perform initial query annotation processing that annotates the initial query with the UCI or other user identifier information used by the index search service to reference the customer value index 232 for relevant and corresponding customer values.

The initial queries received from different users (when they are each associated with different customer schemas), will result in the systems annotating the initial queries differently and identifying different customer values from the customer value index(es) 232, based on being associated with different corresponding customer schemas.

The interaction tracker 186 can be used to track different users and their interactions with the interfaces used to receive search queries and to present the corresponding search results. This interaction tracker 186 obtains the user identifying information needed to annotate initial search query. In some instances, the annotation is explicit, making a modification to the initial query. In other instances, the annotation is implicit, by simply correlating the initial query with user identifying information. Either way, the user identifying information is used by the index search service 230 to identify the customer values associated with a particular user and the user's initial query. These customer values are provided back to the server system for further query understanding and alteration processing by the search query processing model(s) 182.

The index search service 230 also processes the initial query by referencing one or more resource index(es) 234 to identify records of the client (or general public) that match/satisfy the search terms in the initial search query.

Contemporaneously, the server system also further processes the initial search query with the newly received customer values to generate altered search queries.

This processing is illustrated as including one or more of a query rewriting process, an entity extraction process, a table prediction process and/or a query alteration process, each of which will now be described.

The query rewriting process may include rewriting one or more search terms in the initial search query for syntax (e.g., to fix typos, translate terms, lemmatization, stem identification/truncation, and/or to change terms based on other natural language processing). It may also include, additionally or alternatively, changing or adding terms in the initial search query based at least in part on the one or more customer values obtained from the customer value index to use customer values/terms instead of and/or in addition to the terms provided in the initial search query.

The process of entity extraction includes identifying one or more entities associated with the search query based at least in part on the one or more customer values that are obtained from the customer value index, wherein the one or more entities comprising a scope of resource/record type to be searched by the index search service. The entity extraction, more particularly, includes identifying entities from a set of different categories of entities, such as a world common knowledge entity type (e.g., location, data, time, etc.), a business domain knowledge entity type (e.g., table, column or other (CDM) common data model service data information), and a customer database entity type (e.g., database annotations).

An example of entity extraction will now be provided for an initial search query is received that comprises the string of text “What is the estimated revenue for Frakam in 2021?” In this example, the world common knowledge entity is 2021. A second entity (business domain knowledge) that is extracted based on the CDM and schema information for the customer, the second entity extracted is “estimated revenue”, which comprises a particular table or attribute for a customer's database and which, for example, may correspond to a customer's table called “Opportunity.” The last entity extracted is “Frakam,” which comprises a company name according to the customers database annotations. It is possible to identify these entities using the customer values provided by the customer value index.

Then, once the entities are extracted, it is possible to predict which specific table(s) to search for the information desired by the user and that corresponds to their intention behind the initial search query.

The table prediction process may include identifying the specific table(s) explicitly or inferentially identified by the entities identified during the entity extraction (E.g., referenced table “Opportunity” table). The table prediction can also, optionally, be based on additional information and rules associated with different search parameters and that are stored and/or referenced by the search query processing model(s). Said another way, the table prediction process may also be viewed as identifying one or more predicted storage structures (a range of one or more tables or other storage containers) to limit the search query to by the index search service based at least in part on the one or more customer values that are obtained from the customer value index, the one or more predicted storage structures being a subset of all storage structures available for searching by the index search service.

Finally, the query alteration process reformats and/or restructures the query into a format that is processed by the index search service (while referencing one or more resource indexes (234)) to identify search results that match the reformatted and restructured queries. The reformatted or restructured query may be formatted into a SQL or other suitable structured format. Using the foregoing search query example (i.e., “What is the estimated revenue for Frakam in 2021”), the system may generate an altered query that is restructured as “Select estimatedRevenue from Opportunity where createdTime>=2021 and createdTime <2022 and companyName contains “Frakam”.”

Notably, the system will generate more than a single altered search query, in some instances. In fact, the system will generate a plurality of two or more alternate search queries (e.g., 2, 3, 4, 5, or more altered search queries) in these alternative embodiments. Each of the altered search queries will also incorporate a unique set of search terms or values that are reformatted or structured differently than the initial search query. By way of further examples, relative to the foregoing search query, an additional altered search query can be restructured as “Select estimatedRevenue from Opportunity where createdTime>=2021 and createdTime <2022 and companyName contains “Frak*”.” Another example restructured search query may comprise: “Select estimatedRevenue from Opportunity* where createdTime>=2020 and createdTime <2022 and companyName contains “Frakam”.”

Yet another example altered search query may comprise “Select estimatedRevenue where createdTime>=2021 and createdTime <2022 and companyName contains “Frakam”,” in which the restructured alternate query does not specify a particular table range. This may occur, for example, when the customer values do not provide enough information for determining the relevant table(s) or other structures to search.

It will be appreciated from the foregoing examples, the query alteration process may optionally restructure and/or reformat an initial query by adding new search operators to the search terms, such as wildcards, or other operators, as well as by modifying certain terms to provide derivatives, synonyms, abbreviations, acronyms or other derivatives of the initial search terms used in the altered search queries, as well as to the customer values used in the altered search queries.

After the alternate search queries are generated, they are routed to the index search service 230 to obtain corresponding search results/records for each of the queries. The system then uses the search result processing model(s) 188 to perform search result processing and to generate the final results that are presented to the user/client system.

In some instances, all of the search results/records are merged, including the search results from the initial search query and the search results for each of the altered search queries. In other embodiments, only a selected subset of the total number of search records/results are merged, based on rules applied by the model(s) to accommodate different needs and preferences. The initial merging may be referenced as level 1 (L1) processing of the search results.

L2 Ranking is referred to as level 2 search result processing and may comprise ranking performed by a machine-learnable learn-to-rank model/component that ranks records in the search results based on relative importance or perceived relevance to a user. The weighting of relevance applied to different resources during the ranking of the search results can be tuned, for example, with feedback functionality applied to the learn-to-rank model(s) that are used to rank the search record, based on user feedback (e.g., user interactions with search results) and/or based on other eyes-on-analysis performed by third party entities.

In some instances, the feedback is detected as a user interacting with certain search result/records. In other instances, the feedback is a user refraining from interacting with certain search results/records within a certain amount of time. Any feedback received, can be used to further train the model about which information is likely to be more relevant to users in future searches.

The L3 Ranking is search result processing that applies business rules to the search results, such as rules that specify types and quantities of information to provide in the results. The rules may also apply permissions to determine which results to present and/or controls for accessing the search results.

Notably, by merging the original search results with the altered and more focused/scoped search results obtained by the altered search queries, it is possible to provide a user with search results that are contextually relevant to a user and that have a breadth (based on the initial search query) and a targeted depth (based on the altered search queries) that is not accessible with conventional systems.

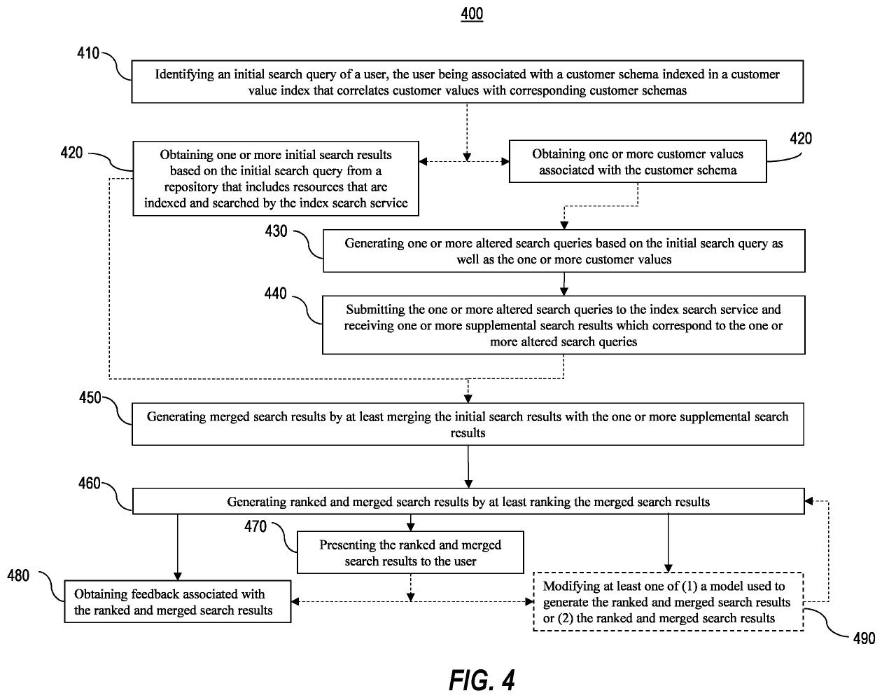

Attention will now be directed to FIG. 4, which illustrates a flow diagram 400 that includes various acts associated with exemplary methods that can be implemented by the computing system(s) referenced herein. As shown, the flow diagram 400 includes a plurality of acts (act 410, act 420, act 430, act 440, act 450, act 460, act 470, act 480, and act 490) which are associated with various methods for processing search queries.

The first illustrated act is the computing system identifying an initial search query of a user, wherein the user is associated with a customer schema indexed in a customer value index that correlates customer values with corresponding customer schemas (act 410). Then, based on a context of the search query, including the association of the user with the customer schema indexed in the customer value index, the systems obtain (1) one or more initial search results based on the initial search query from a repository that includes resources that are indexed and searched by the index search service, and (2) one or more customer values associated with the customer schema (act 420). Technical benefits associated with mapping specific customer schema information to different users includes enabling the identification of customer values from a single search performed by a user, based on simply the user's identity (or the identify of the system the user is using). This way, the user does not need to provide additional identifying information along with each search, saving computational processing and improving the overall user experience.

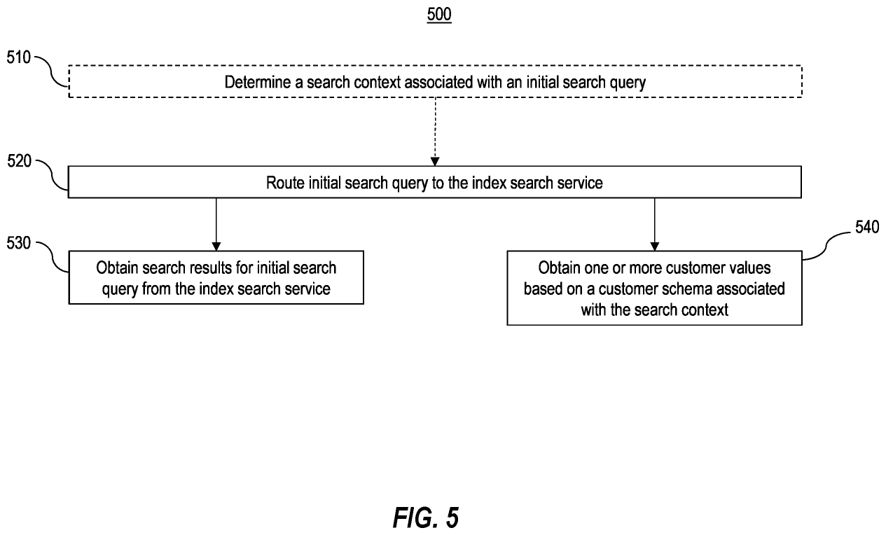

Corresponding acts for obtaining the initial search result and customer values are shown in the flow diagram 500 of FIG. 5. As shown, these acts may include the system determining a search context associated with an initial search query (act 510). This may further include identifying the UCI of a user and/or otherwise receiving user information that is associated with a particular user or customer in the customer value index. This information can be obtained by querying the user for the information and/or by automatically determining attributes from a user/customer (e.g., analyzing the user's device characteristics or location). The context may also include determining a particular department or task the user is associated with at a particular time.

Once the initial search context (e.g., user identification and/or context) is determined, the system will route the initial search query to the index search service with the identifying context information (act 520). The initial query is processed by the index search service to identify relevant search results to the initial query. The context information for the search is used to identify customer values relevant to the user identity/context and that are unique to a customer schema associated with the user and/or user context.

The system obtains the search results for the initial search query (act 530) and the corresponding customer values based on the customer schema associated with the search context (act 540) from the index search service. Technical benefits associated with receiving the customer schema values along with the search results includes the ability to augment the search with additional searches that are possibly more targeted and relevant for a user (based on relevant customer values associated with the user/customer) than the simple search results that are based on the query terms.

Notably, the one or more customer values associated with the customer schema (which are received concurrently with the initial search results) are different than other customer values that are associated with different customer schemas indexed in the customer value index and that are returned by the index search service to the computing system in response to the computing system sending one or more different search queries to the index search service for the different user(s) associated with the different customer schema(s).

The systems also concurrently generate one or more altered search queries, as previously described, based on the initial search query as well as the one or more customer values (act 430) and submit the one or more altered search queries to the index search service to receive one or more corresponding supplemental search results (act 440). Technical benefits associated with performing the additional searches includes obtaining a greater depth of related search results that are particularly/contextually relevant to the specific user/customer performing the search. This is a technical benefit, by improving the accuracy of the search being performed, to be dynamically more contextually relevant to a specific user/customer than a simple search based only on query terms received from the user.

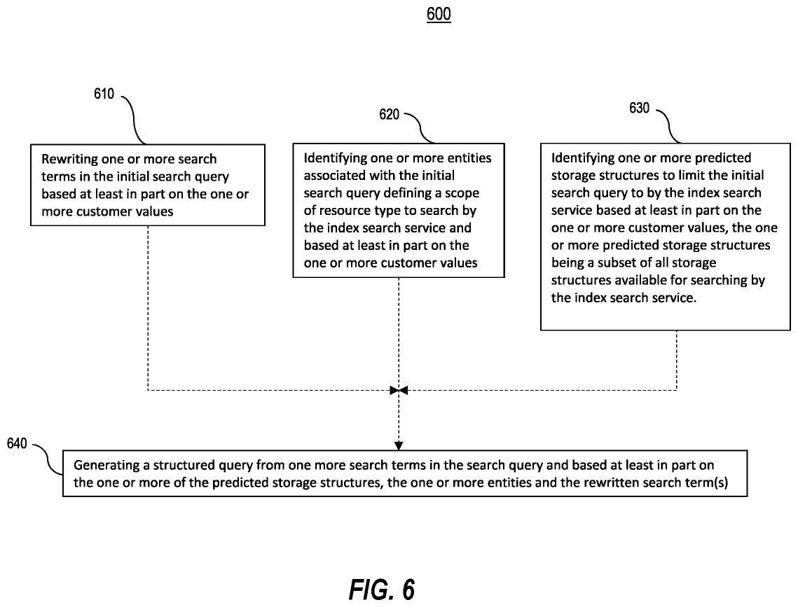

As previously mentioned, processes implemented by the system for generating the altered search queries (act 430), as further shown in the flow diagram 600 of FIG. 6, include one or more of the system (1) rewriting one or more search terms in the initial search query based at least in part on the one or more customer values obtained from the customer value index and/or for basic syntax (act 610), (2) identifying one or more entities associated with the search query based at least in part on the one or more customer values that are obtained from the customer value index, the one or more entities comprising a scope of resource type to search by the index search service (act 620), (3) identifying one or more predicted storage structures to limit the search query to by the index search service based at least in part on the one or more customer values that are obtained from the customer value index, the one or more predicted storage structures being a subset of all storage structures available for searching by the index search service (act 630), and/or (4) generating a structured query from one more search terms in the search query and, optionally, based at least in part on the one or more predicted storage structures and/or the one or more entities determined by using the customer values (act 640).

The illustrated flow diagram 400 also includes acts for generating ranked and merged search results (act 460) by at least merging the initial search results with the one or more supplemental search results and by further ranking the merged search results to generate a final set of ranked and merged search results for presentation to the user in response to the initial query (act 470). Technical benefits of merging the results include improving accuracy and breadth of the search that is performed.

Notably, the one or more altered search queries and corresponding results may comprise one or any number altered search queries and results (e.g., 2, 3, 4, 5, or more). Each of the altered search queries will incorporate a unique set of search terms or values that are reformatted or structured differently than the initial search query. The corresponding results may be the same or different.

Any combination of the corresponding altered search results will be merged and ranked into the merged and ranked search results. In some instances, only search results that are determined to meet a predetermined threshold of relevance are included in the merged set of search results, to avoid further processing of irrelevant search results.

In some instances, the systems further implement feedback loops to improve training of the learn-to-rank models used by the systems by obtaining feedback associated with the ranked and merged search results (act 480) and, responsively based on the feedback, modifying at least one of (1) the model(s) used to generate the ranked and merged search results or (2) the ranked and merged search results themselves (act 490).

The feedback may include any user interaction with the ranked and merged search results, such as user input selecting or accessing a resource identified in the ranked and merged search results. The feedback may also, alternatively or additionally, include a determination that one or more resources included in the ranked and merged search results is not selected or accessed by the user within a predetermined time.

There are many technical benefits associated with the foregoing embodiments, including the functionality provided by facilitating how search results are obtained that are contextually relevant to a user, with a breadth and depth that is not accessible with conventional systems. This functionality is aided by the systems supplementing initial queries with supplemental altered queries that are based on the initial queries as well as unique customer information related to the user. The technical benefits further include facilitating the generation of the supplemental and altered search queries without requiring the user to explicitly provide the syntax for restructuring the altered search queries. The technical benefits also include facilitating a manner in which corresponding search results are merged and ranked for the user. The technical benefits also include facilitating training of learn-to-rank models in a manner that considers user intention for different search queries, as well as user interactions with the search result content, to improve the manner in which the models are able to identify relevant search results.

While the foregoing embodiments are described in terms of methods and method acts being implemented by a computing system, it will also be appreciated that the disclosed embodiments comprise special purpose computing systems that are specifically configured to implement the disclosed functionality of those method. For instance, the disclosed embodiments explicitly include computing systems that comprise one or more processors (e.g., hardware processors) and one or more storage devices (e.g., hardware storage devices) having stored computer-executable instructions that are executable by the one or more processors for configuring the computing system to implement the disclosed method(s) for dynamically processing search queries based on customer information.

In these embodiments, the disclosed systems are specifically configured to identify an initial search query of a user, the user being associated with a customer schema indexed in a customer value index that correlates customer values with corresponding customer schemas. Then, based on a context of the search query, including the association of the user with the customer schema indexed in the customer value index, the systems are further configured to obtain (1) one or more initial search results based on the initial search query from a repository that includes resources that are indexed and searched by the index search service, and (2) one or more customer values associated with the customer schema.

The systems are also configured to generate one or more altered search queries based on the initial search query as well as the one or more customer values. For instance, the systems are configured to generate the one or more altered search queries by (1) optionally rewriting syntax of the initial search query, (2) defining a scope of resource type to search by the index search service, based at least in part on the one or more customer values that are obtained from the customer value index, (3) identifying one or more predicted storage structures to limit the search query to by the index search service based at least in part on the one or more customer values that are obtained from the customer value index, the one or more predicted storage structures being a subset of all storage structures available for searching by the index search service and/or (4) generating a structured query from one more search terms in the search query and based at least in part on the one or more predicted storage structures and the scope of resource type to search. The format of the structured query may be a sequel (SQL) query format, or another type of structured format that is different than the format of the initial query.

The systems are also configured, to submit the altered search queries to the index search service and/or to another search service and to receive one or more supplemental search results which correspond to the one or more altered search queries.

The systems are also configured to generate merged search results by at least merging the initial search results with the one or more supplemental search results and to generate ranked and merged search results by at least ranking the merged search results, and to present the ranked and merged search results to the user.

The systems are also configured to obtain feedback associated with the ranked and merged search results and to modify at least one of (1) a model used to generate the ranked and merged search results or (2) the ranked and merged search results based on the feedback.

Computer Configurations

Embodiments of the present invention may comprise or utilize a special purpose or general-purpose computer (e.g., computing system 110 and/or client system 120) including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media (e.g., storage 140 and 124 of FIG. 1) that store computer-executable instructions (e.g., 118 of FIG. 1) are physical storage media. Computer-readable media that carry computer-executable instructions are transmission media. Thus, by way of example, and not limitation, embodiments of the invention can comprise at least two distinctly different kinds of computer-readable media: physical computer-readable storage media (i.e., hardware storage devices) and transmission computer-readable media.

Physical computer-readable storage media, which is distinct and distinguished from transmission computer-readable media, include physical and tangible hardware. Examples of physical computer-readable storage media include hardware storage devices such as RAM, ROM, EEPROM, CD-ROM or other optical disk storage (such as CDs, DVDs, etc.), magnetic disk storage or other magnetic storage devices, or any other hardware which can be used to store desired program code means in the form of computer-executable instructions or data structures and which can be accessed by a general purpose or special purpose computer and which are distinguished from merely transitory carrier waves and other transitory media that are not configured as physical and tangible hardware.

A “network” (e.g., network 135 of FIG. 1) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include any network links and/or data links, including transitory carrier waves, which can be used to carry, or desired program code means in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. Additionally, it will be appreciated that the scope of the invention also includes combinations of the disclosed features that are not explicitly stated, but which are contemplated, and which can include any combination of the disclosed features.

The scope of the invention is, therefore, indicated by the appended claims rather than by the foregoing description. All changes which come within the meaning and range of equivalency of the claims are to be embraced within their scope.

What is claimed:

1. A method implemented by a computing system for dynamically processing search queries based on customer information, the method comprising:
the computing system identifying an initial search query of a user, the user being associated with a customer schema indexed in a customer value index that correlates customer values with corresponding customer schemas;
based on a context of the search query, including the association of the user with the customer schema indexed in the customer value index, obtaining (1) one or more initial search results based on the initial search query from a repository that includes resources that are indexed and searched by the index search service, and (2) one or more customer values associated with the customer schema;
generating one or more altered search queries based on the initial search query as well as the one or more customer values;
submitting the one or more altered search queries to the index search service and receiving one or more supplemental search results which correspond to the one or more altered search queries;
generating merged search results by at least merging the initial search results with the one or more supplemental search results;
generating ranked and merged search results by at least ranking the merged search results; and
presenting the ranked and merged search results to the user.

2. The method of claim 1, the method further comprising the system:
obtaining feedback associated with the ranked and merged search results; and
based on the feedback, modifying at least one of (1) a model used to generate the ranked and merged search results or (2) the ranked and merged search results.

3. The method of claim 2, wherein obtaining feedback includes receiving input selecting or accessing a resource identified in the ranked and merged search results.

4. The method of claim 2, wherein obtaining the feedback includes determining one or more resources included in the ranked and merged search results is not selected or accessed by the user within a predetermined time.

5. The method of claim 2, wherein the system modifies the model used to generate the ranked and merged search based on the feedback.

6. The method of claim 1, wherein generating the one or more altered search queries includes:
rewriting one or more search terms in the initial search query based at least in part on the one or more customer values obtained from the customer value index.

7. The method of claim 1, wherein generating the one or more altered search queries includes:
identifying one or more entities associated with the initial search query based at least in part on the one or more customer values that are obtained from the customer value index, the one or more entities comprising a scope of resource type to search by the index search service.

8. The method of claim 1, wherein generating the one or more altered search queries includes:
identifying one or more predicted storage structures to limit the initial search query to by the index search service based at least in part on the one or more customer values that are obtained from the customer value index, the one or more predicted storage structures being a subset of all storage structures available for searching by the index search service.

9. The method of claim 8, wherein generating the one or more altered search queries further includes:
identifying one or more entities associated with the initial search query based at least in part on the one or more customer values that are obtained from the customer value index, the one or more entities comprising a scope of resource type to search by the index search service.

10. The method of claim 9, wherein generating the one or more altered search queries further includes:
generating a structured query from one more search terms in the initial search query and based at least in part on the one or more predicted storage structures and the one or more entities.

11. The method of claim 1, wherein generating the one or more altered search queries includes:
generating a structured query from one more search terms in the initial search query and based at least in part on the one or more customer values that are obtained from the customer value index.

12. The method of claim 1, wherein (1) the one or more initial search results, and (2) the one or more customer values are obtained by the index search service in response to the computing system first sending the initial search query to the index search service with information that identifies at least the context of the initial search query which is usable by the customer value index to identify the one or more customer values associated with the customer schema associated with the user.

13. The method of claim 12, wherein the one or more customer values associated with the customer schema are different that other customer values associated with a different customer schema indexed in the customer value index and that are returned by the index search service to the computing system in response to the computing system sending a different search query than the initial search query to the index search service for a different user associated with a different customer schema.

14. The method of claim 1, wherein the index search service is remotely located from the computing system.

15. The method of claim 1, wherein the one or more altered search queries comprise a plurality of altered search queries, and wherein the one or more supplemental search results comprise a plurality of supplemental search results that are merged and ranked into the merged and ranked search results by the computing system.

16. A computing system comprising:
one or more processors; and
one or more storage devices having stored computer-executable instructions that are executable by the one or more processors for configuring the computing system to implement a method for dynamically processing search queries based on customer schema information, and by at least configuring the computing system to perform the following:
to identify an initial search query of a user, the user being associated with a customer schema indexed in a customer value index that correlates customer values with corresponding customer schemas;
based on a context of the search query, including the association of the user with the customer schema indexed in the customer value index, to obtain (1) one or more initial search results based on the initial search query from a repository that includes resources that are indexed and searched by the index search service, and (2) one or more customer values associated with the customer schema;
to generate one or more altered search queries based on the initial search query as well as the one or more customer values;
to submit the one or more altered search queries to the index search service and receiving one or more supplemental search results which correspond to the one or more altered search queries;
to generate merged search results by at least merging the initial search results with the one or more supplemental search results;
to generate ranked and merged search results by at least ranking the merged search results;
to present the ranked and merged search results to the user;
to obtain feedback associated with the ranked and merged search results; and
to modify at least one of (1) a model used to generate the ranked and merged search results or (2) the ranked and merged search results based on the feedback.

17. The computing system of claim 16, wherein the one or more altered search queries comprise a plurality of altered search queries, and wherein the one or more supplemental search results comprise a plurality of supplemental search results that are merged and ranked into the merged and ranked search results by the computing system.

18. The computing system of claim 16, wherein generating the one or more altered search queries includes:
defining a scope of resource type to search by the index search service, based at least in part on the one or more customer values that are obtained from the customer value index;
identifying one or more predicted storage structures to limit the search query to by the index search service based at least in part on the one or more customer values that are obtained from the customer value index, the one or more predicted storage structures being a subset of all storage structures available for searching by the index search service; and
generating a structured query from one more search terms in the search query and based at least in part on the one or more predicted storage structures and the scope of resource type to search.

19. The computing system of claim 18, wherein the structured query is a different format than the initial search query and is formatted as a sequel (SQL) query format.

20. The computing system of claim 16, wherein the one or more customer values associated with the customer schema are different that other customer values associated with a different customer schema indexed in the customer value index and that are returned by the index search service to the computing system in response to the computing system sending a different search query to the index search service for a different user associated with a different customer schema.
